(19) United States
(12) Patent Application Publication
(10) Pub. No.: US 2013/0193062 A1
(43) Pub. Date: Aug. 1, 2013

(54) HYDRAULIC FILTER ELEMENT AND ASSOCIATED PRODUCTION METHOD

(71) Applicants: Wilhelm Schoepp, Altlussheim (DE); Reinhard Wierling, Pfedelbach (DE)

(72) Inventors: Wilhelm Schoepp, Altlussheim (DE); Reinhard Wierling, Pfedelbach (DE)

(73) Assignee: Mahle International GmbH, Stuttgart (DE)

(21) Appl. No.: 13/811,192

(22) PCT Filed: Jul. 14, 2011
(86) PCT No.: PCT/EP2011/062089

§ 371 Date: Apr. 4, 2013

(30) Foreign Application Priority Data
Jul. 20, 2010 (DE) 10 2010 031 804.3

(51) Int. Cl. B01D 29/11

(52) U.S. Cl. CPC B01D 29/11
USPC 210/484; 53/441

(57) ABSTRACT

A hydraulic filter element may include cylindrical filter body having a filter material folded in a star-shaped manner. A cylindrical inner frame may be radially supported on an inside of the filter body. A cylindrical sleeve may be permeable to a respective hydraulic medium and arranged radially against the outside of the filter body under prestress, wherein the sleeve may include a knitted textile material.

### CROSS-REFERENCE TO RELATED APPLCATIONS

This application claims priority to German Patent Application 10 2010 031 804.3 filed on Jul. 2010, and International Patent Application PCT/EP2011/062089 filed on Jul. 14, 2011, both of which are hereby incorporated by reference in their entirety.

### TECHNICAL FIELD

The present invention relates to a hydraulic filter element, in particular an oil filter element. The invention also relates to a method for producing such a hydraulic filter element.

### BACKGROUND

Hydraulic filter elements usually have a cylindrical filter body, which is produced from a filter material which is folded in a star-shaped manner. Owing to the large pressure differences between an outer untreated side and an inner clean side which occur during use, such a hydraulic filter element can also be equipped with a cylindrical inner frame on which the filter body can be supported radially on the inside. Furthermore, axial end discs can be provided, which are arranged at opposite axial ends of the filter body.

During the production of such hydraulic filter elements, the inner frame is inserted into the folded filter material and the filter material is prestressed against the inner frame with the aid of tensioning elements such as bands, ties and the like. In this prestressed state the end discs are attached in order to fix the relative position between the filter material and the inner frame. After the end discs have been attached, the above-mentioned tensioning elements must be removed again. The attachment and removal of such tensioning elements requires comparatively time-intensive and relatively cost-intensive production steps. Furthermore, these steps must be carried out with a relatively high level of care in order to obtain the desired contact between the filter material and the inner frame, which is of especial importance for achieving the necessary service life for the hydraulic filter element.

DE 10 2009 005 980, which has subsequently been published, discloses a hydraulic filter element, which has a cylindrical filter body consisting of a filter material folded in a star-shaped manner, a cylindrical inner frame, on which the filter body is supported radially on the inside, and a cylindrical sleeve, which is permeable to the respective hydraulic medium and bears radially against the outside of the filter body under prestress. In the known hydraulic filter element, the sleeve consists of a nonwoven material, which can in particular be designed in a shrinkable manner.

### SUMMARY

The present invention is concerned with the problem of specifying an improved embodiment for a hydraulic filter element or for an associated production method, which is characterised in particular in that it can be realised comparatively cost-effectively, has high reproducibility and preferably supports a long service life for the hydraulic filter element.

This problem is solved according to the invention by the subject matter of the independent claims. Advantageous embodiments of the invention are the subject of the dependent claims.

The present invention is based on the general concept of equipping the filter element with a cylindrical sleeve, which is arranged on the outside of the filter body and is permeable to the respective hydraulic medium and bears against the filter body under radial prestress. This sleeve can be used during production of the filter element to prestress or press the filter material against the inner frame. The particular advantage of the sleeve is that it can remain on the filter element after production of the latter, as it is permeable to the respective hydraulic medium. This reduces the effort during production of the filter element. Furthermore, such a sleeve can extend in the axial direction over the entire length or height of the filter body, which improves the prestressing of the filter material against the inner frame and in particular allows the said prestress to be produced uniformly and with a high degree of reliability. Furthermore, the filter element equipped with the sleeve has improved functionality, as the sleeve can act as a prefilter or coarse dirt filter, which for example prevents or at least reduces damage or impairment of the filter material owing to large-grained impurities. In this respect, the sleeve has a positive effect on the service life of the filter element. The increased reliability and improvement in the pressing of the filter material against the inner frame during production of the filter element results in high-quality filter elements, which have a comparatively long service life.

Moreover, the sleeve bears against the filter body under prestress. This prestress is attributable to the prestressing effect of the sleeve, with which the sleeve presses the filter material against the inner frame during production of the filter element. An embodiment in which the sleeve presses the filter material against the inner frame in a play-free manner is particularly advantageous. This produces an exactly defined relative position between the filter material and the inner frame even during production of the filter element, which results in a particularly long service life for the filter element.

In the hydraulic filter element according to the invention, the sleeve consists of a textile material. Such a textile material is woven or knitted and thereby has an ordered structure. This makes is possible in particular to provide the textile material with direction-dependent properties, such as shrinkability, elasticity or extensibility. The properties of the textile material can likewise be set comparatively exactly by selecting the fibres used for production of the textile material, e.g. with regard to fibre material and fibre strength.

The ordered structure of the textile material has a larger free surface area compared to an unordered structure of a nonwoven material, as a result of which the flow resistance of the textile material is lower than that of a comparable nonwoven material.

An embodiment in which the sleeve consists of a textile shrinking material is particularly advantageous. A shrinking material is characterised in that it shrinks in terms of its dimensions under certain boundary conditions, in particular during a thermal treatment. The use of a sleeve consisting of a textile shrinking material allows the sleeve to shrink onto the filter body and thus at the same time the filter material to shrink onto the inner frame during production of the filter element. This means that the filter material is compressed by the shrinkage of the sleeve to such an extent that it comes to bear against the inner frame, it being possible in particular for all the radial play between the filter material and the inner frame to be eliminated. The use of a shrinking material for the sleeve thus simplifies the production of the filter element and results in an extremely high reproducibility with high production quality at the same time.

According to a particularly advantageous embodiment, the sleeve can thus be shrunk onto the filter body, the textile material used for the sleeve being designed in such a manner that it shrinks at least in the circumferential direction or preferably in the circumferential direction or exclusively in the circumferential direction during the shrinking process. The use of such a shrinkable textile material allows the production of the hydraulic filter element to be considerably simplified. For example, a blank can be produced from a textile material for the sleeve, the inner cross section of which is greater than the outer cross section of the filter body, as a result of which the sleeve can be pulled over the filter body particularly easily. During the shrinkage process, the textile material contracts uniformly in the circumferential direction of the sleeve and thereby effects a uniform radial prestress, which brings the filter material to bear against the inner frame. As the prestress forces introduced via the sleeve are transmitted uniformly and thus protectively to the filter material, the risk of damage to the filter material can be reduced. Furthermore, the uniform shrinkage of the sleeve results in the fold structure of the filter body also remaining uniform.

According to another advantageous embodiment, the textile material can have a warp/woof structure with warp fibres running parallel to each other and woof fibres running transversely thereto. Such a warp/woof structure can be produced particularly cost-effectively from web material or flat material. A configuration in which the warp fibres and the woof fibres consist of different plastics or plastic combinations is particularly advantageous. For example, the warp fibres consist of polyester, whereas the woof fibres consist of polyamide, or vice versa. This allows different properties of the textile material to be set differently in directions perpendicular to each other, such as shrinkability and elasticity or extensibility.

The flat or web-shaped textile material can expediently be formed in such a manner with respect to the sleeve that the warp fibres run axially inside the sleeve while the woof fibres extend in the circumferential direction, or vice versa. The above-mentioned properties can thereby be designed differently in the axial direction and in the circumferential direction.

An embodiment in which the shrinkable textile material is configured in such a manner that it has greater shrinkage in the circumferential direction than in the axial direction is particularly advantageous. This means that the textile material contracts more in the circumferential direction than in the axial direction during the shrinking process, so that substantially only the radial prestress with which the sleeve presses the filter material against the inner frame is increased, it being possible for the cross section of the sleeve to be reduced in correspondence with the cross section of the filter body, while the axial length of the sleeve hardly changes.

According to another advantageous embodiment, the sleeve can consist of an elastic textile material and be extended elastically in the circumferential direction in such a manner that the circumferential extension of the textile material or of the sleeve produces the prestress which presses the sleeve against the filter material of the filter body. Therefore, no additional external forces have to be applied to press the sleeve against the filter body. For the production of the hydraulic filter element, this means that no additional external forces have to be applied during production in order to press the filter body against the inner frame, as the prestress forces necessary for this can be produced with the aid of the sleeve or with the aid of the textile material.

The textile material used for realising the sleeve is advantageously more elastically extensible in the circumferential direction than in the axial direction when it is formed into the sleeve. This results in particular in the axial extent of the sleeve not changing or only changing to an insubstantial extent when it is extended in the circumferential or radial direction. This simplifies the use of the sleeve if it is to extent for example over the entire axial height of the filter body and is extended in the circumferential direction when pulling it onto the filter body. The comparatively large extension achieved thereby then has only a reduced effect on the axial dimension of the sleeve.

For example, the textile material forming the sleeve can be manufactured in such a manner that it has an elastic extensibility of at least 20% or of at least 100% in the circumferential direction and an elastic extensibility of no more than 10% or no more than 1% in the axial direction when it forms the sleeve.

According to another advantageous embodiment, when the sleeve is in the mounted state, the textile material can be extended so far in the circumferential direction that at least 80% of the elastic extensibility of the textile material in the circumferential direction is exhausted. This means that, starting from an elastic extension range which goes from 0%, which corresponds to no extension, to 100%, which corresponds to the maximum elastic extension and describes the limit of the plastic extension, the elastic extensibility range is largely exhausted when the sleeve is in the mounted state, so that the greatest possible prestress is set in a similar manner to a spring. In the ideal case, the maximum extension of the textile material, which corresponds to the maximum settable prestress, is achieved when the sleeve is in the mounted state.

The fibres from which the textile material can be produced consist for example of polyamide or polyester. Elastane fibres can likewise be added. The fibres themselves can have a diameter in the range from 20 μm to 70 μm. The textile material then has a thickness in the range from 250 μm to 700 μm.

The sleeve can be formed as a hose or as a wound web material. A configuration of the sleeve as a hose can be realised for example by circular knitting or circular weaving of the textile material. A configuration as a wound web material is produced by corresponding joining, in which overlapping circumferential ends of the flat material or web material are connected to each other, for example by means of an adhesive process or fusing process (ultrasonic fusion).

Fibres of different materials can also be used in the production of the textile material. In particular in textile materials with warp and woof, the warp fibres can consist of a different material from the woof fibres. Different properties such as shrinkability and/or extensibility can thereby be set in the woof direction and in the warp direction. Furthermore, in a textile material which has stitches, direction-dependent properties such as shrinkability and extensibility can be realised by the type of stitches used. Fibres for producing the textile material are for example polyester or polyamide. Preferred fibre thickness are between 0.2 mm and 0.5 mm, preferably approximately 0.3 mm. Pore sizes or stitch sizes can preferably be in the range from 200 μm to 500 μm, preferably in the region of 300 μm. The weight per unit area of the textile material is preferably in the range from 50 g/m² to 200 g/m².

With a shrinkable textile material, the production of the filter element can be carried out in such a manner that the sleeve is first produced in the unshrunk state with an excess with respect to the filter body, so that the sleeve can be pulled particularly easily onto the filter body for the production. There can be radial play radially between the sleeve and the filter body. The sleeve and the filter material contract greatly in the circumferential direction owing to the subsequent shrinking process. Shrinkages of up to 50% are realistic.

Further important features and advantages of the invention result from the sub-claims, from the drawings and from the associated description of the figures on the basis of the drawings.

It is to be understood that the previously mentioned features and the features which are still to be mentioned below can be used not only in the respectively specified combination, but also in other combinations or alone, without departing from the scope of the present invention.

Preferred exemplary embodiments of the invention are illustrated in the drawings and are described in more detail in the following description, wherein identical reference numbers refer to identical or similar or functionally identical components.

### BRIEF DESCRIPTION OF THE DRAWINGS

In the figures

FIG. 1 shows a highly simplified principle longitudinal section through a hydraulic filter element,

FIG. 2 shows a highly simplified, principle cross section of the hydraulic filter element during production,

FIG. 3 shows a cross section as in FIG. 2, but after production,

FIG. 4 shows a highly simplified, enlarged view of a textile material.

### DETAILED DESCRIPTION

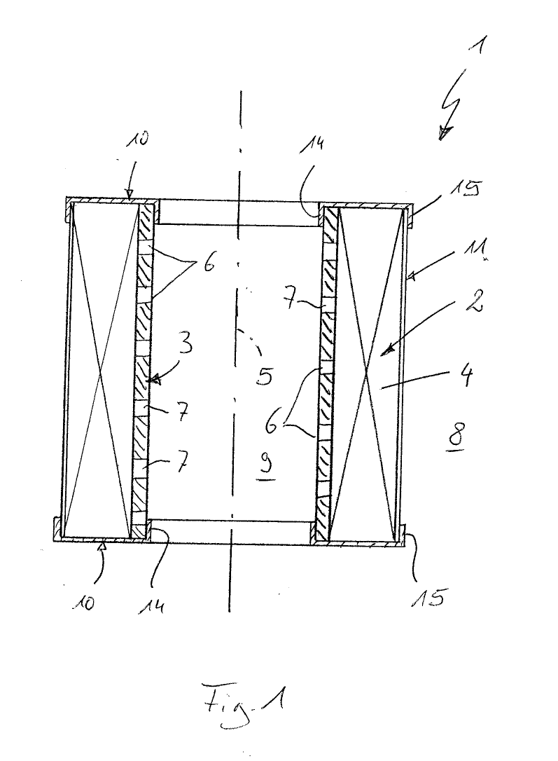

According to FIGS. 1 to 3, a hydraulic filter element 1, which can preferably be an oil filter element, comprises a cylindrical filter body 2 and a cylindrical inner frame 3. The filter body 2 is produced with the aid of a filter material 4, which is folded in a star-shaped manner. The inner frame 3 is arranged coaxially to the filter body 2, the filter body 2 enveloping the inner frame 3. A common longitudinal centre axis is labelled 5 in FIG. 1. The inner frame 3 is designed to be permeable to the respective hydraulic medium, in particular oil. To this end, it can be formed with perforations 6, which consist of a multiplicity of individual through-openings 7. The filter body 2 is supported radially on the inside on the inner frame 3. The filter body 2 can thereby be exposed to relatively large pressure differences between an outer untreated space 8 and an inner clean space 9 during use.

In the example, the hydraulic filter element 1, which is also referred to below as filter element 1 for short, is provided with two end discs 10, which are arranged at opposite axial ends of the filter body 2. In the example, both end discs 10 are structurally identical. However, in a different embodiment they can also be different. At least one of the end discs 10 is centrally open in order to allow fluid communication with the clean space 9 when the filter element 1 is in the installed state.

The filter element 1 presented here is also provided with a sleeve 11, which is cylindrical and likewise extends coaxially to the longitudinal centre axis 5. The sleeve 11 is arranged radially on the outside of the filter body 2. It is permeable to the respective hydraulic medium. The sleeve 11 has greater permeability, that is, has lower flow resistance than the filter material 4 of the filter body 2.

In the example, the sleeve 11 extends substantially over the entire axial length of the filter body 2. It envelops at least the entire outer side of the filter body 2 which extends between the end discs 10.

The sleeve 11 preferably bears against the filter body 2 under a prestress. The sleeve 11 bears against the filter body 2 e.g. with a prestress which is sufficient to press the filter material 4 against the inner frame 3 in a play-free manner. In the finished filter element 1 this feature is apparent in that the filter material 4 bears against the inner frame 3 in a play-free manner.

The sleeve 11 consists of a textile material which is produced by weaving or knitting. Such a textile material can for example be produced from corresponding plastics such as polyester or polyamide. It has sufficient resistance to the respective hydraulic medium and is particularly suitable for realising a prefilter effect.

A configuration in which the sleeve 11 is produced or consists of a shrinking material is particularly advantageous. The shrinking material can reduce its dimensions, that is, shrink, under corresponding boundary conditions, in particular at a shrinking temperature above the usual operating temperature range of the hydraulic filter element 1. Play-free bearing of the sleeve 11 against the filter material 4 and, given corresponding shrinkage forces, of the filter material 4 against the inner frame 3 can be realised thereby.

The use of a shrinking material which has direction-dependent shrinkage is particularly advantageous. Shrinkage means the shrinking behaviour, that is, the shrinking under the corresponding boundary conditions, that is, in particular at the respective shrinking temperature. The shrinking material can preferably be designed in such a manner that it has greater shrinkage in the circumferential direction of the filter body 2 than in the axial direction of the filter body 2. For example, the shrinkage in the circumferential direction can be at least three times or at least ten times greater than in the axial direction. For example, an embodiment is conceivable in which the shrinking material shrinks by less than 1% in the axial direction, whereas it shrinks by at least 3 to 15% in the circumferential direction. Direction-dependent shrinking behaviour can be realised e.g. by targeted fibre orientation in the shrinking material.

The use of such a material which shrinks in a direction-dependent manner makes it possible in particular to carry out the shrinking process in such a manner that the sleeve 11 still extends substantially completely over the entire axial length of the filter body 2 after shrinking, whereas a comparatively high stress is produced in the circumferential direction, which drives the filter material 4 radially inwards against the inner frame 3.

The sleeve 11 can be formed as a wound web material. The ends of the web material, which bound each other in the circumferential direction, can then overlap each other and be adhesively bonded or fused to each other. The circumferential ends can likewise be butt-connected to each other. However, an embodiment in which the sleeve 11 is formed as a hose, so that it can be pushed particularly easily onto the filter body 2 and additional fastening steps can be omitted, is particularly advantageous.

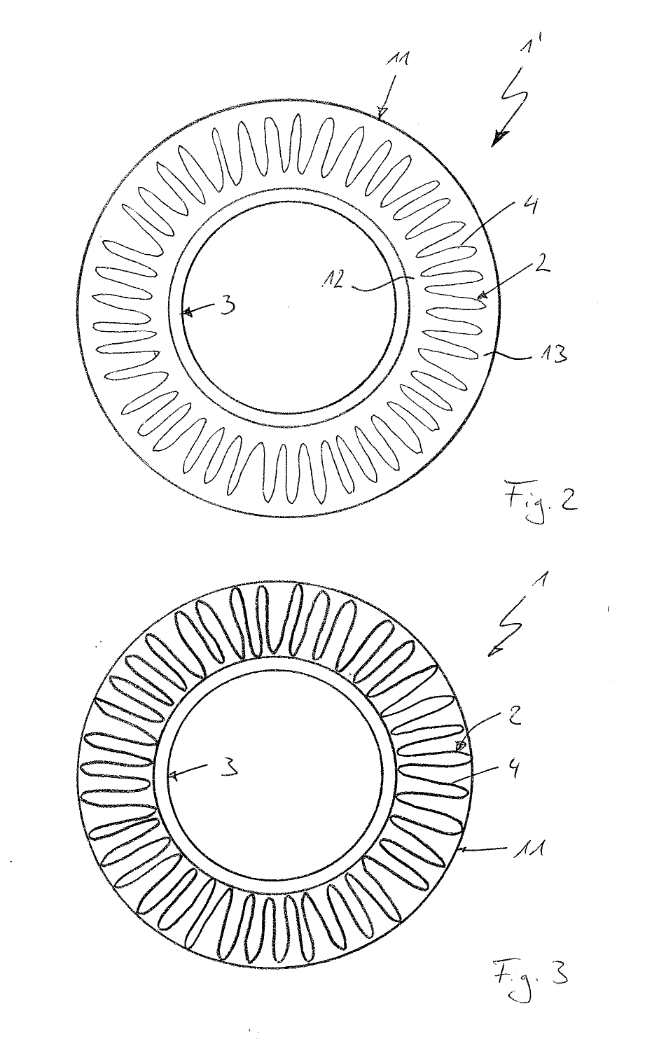

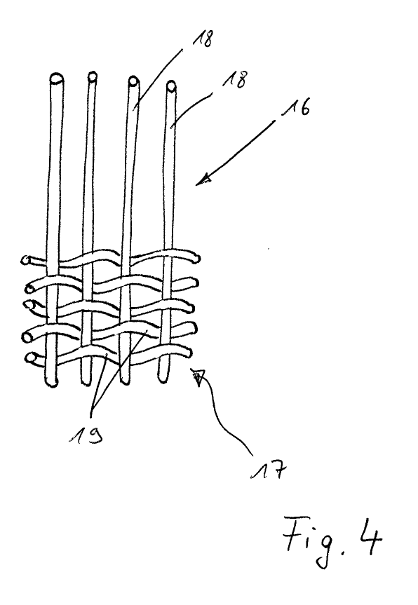

A method for producing such a hydraulic filter element 1 is explained in more detail below with reference to FIGS. 2 and 3. FIG. 2 shows an advanced stage of production in which the inner frame 3, the filter body 2 and the sleeve 11 are arranged coaxially to each other. This intermediate state of the filter element 1 is labelled 1′ in FIG. 2. In this intermediate state, it is possible for an inner radial play 12 to occur radially between the inner frame 3 and the filter material 4. Additionally or alternatively, an outer radial play 13 can occur between the sleeve 11 and the filter material 4. Alternatively, the sleeve 11 can also be applied in such a manner that it bears against the outside of the filter material 4 from the start.

The sleeve 11 can be applied in such a manner that it presses the filter material 4 against the inner frame 3. This can be realised particularly simply in that a shrinkable sleeve 11, that is, a sleeve 11 produced from a shrinking material, is used. The sleeve 11 can be shrunk under corresponding boundary conditions. Thermal shrinking methods are preferred in this case. The shrinking material contracts, that is, shrinks, at a corresponding shrinking temperature. As result, the circumference of the sleeve 11 is reduced. The outer radial play 13 which may be present is thereby eliminated and the sleeve 11 comes to bear against the outside of the filter material 4. By continuing the shrinking process, the sleeve 11 reduces its circumference further, as a result of which a tensile stress orientated in the circumferential direction is produced in the sleeve 11. This tensile stress is supported inwardly on the filter material 4, as a result of which a compressive force orientated radially inwards is introduced into the filter material 4. With a corresponding design of the shrinking process or with a corresponding design of the sleeve material and with corresponding dimensioning of the sleeve 11, the inner radial play 12 can thereby also be eliminated, so that the filter material 4 comes to bear radially directly on the inner frame 3.

As soon as the sleeve 11 is applied to the filter material 4 in such a manner that it is pressed radially inwardly against the inner frame 3, the relative position produced in this manner between the filter material 4 and the inner frame 3 can be fixed. This relative position can for example be fixed by mounting the end discs 10. The end discs 10 can for example be adhesively bonded to the filter material 4. As soon as the adhesive has hardened, the relative position between the filter material 4 and the end discs 10 is fixed and thus also with respect to the inner frame 3. The adhesive bonding expediently takes place in such a manner that the end discs 10 are at the same time also fixed to the inner frame 3.

In the example of FIG. 1, the end discs 10 each have an inner collar 14, which encloses an inner edge (not shown in detail) of the end disc 10 and which overlaps the inner frame 3 radially on the inside. Moreover, the end discs 10 in the example of FIG. 1 each have an outer collar 15, which encloses an outer edge (not shown in detail) of the respective end disc 10. Furthermore, the respective outer collar 15 fits over the filter body 2 and in the example also the sleeve 11 radially on the outside in the axial direction. Depending on the fixing between the end disc 10 and the filter body 2, the sleeve 11 can thus be fixed, in particular adhesively bonded, to the end discs 10.

According to a particularly advantageous embodiment, the sleeve 11 can be produced from a printable material, so that it is in particular possible to use the sleeve 11 as a carrier of printed information. For example, use instructions, safety information, manufacturer name and manufacturer branding and the like can be printed on the sleeve 11.

The sleeve 11 makes it easier to handle the filter elements 1. At the same time, it can provide a certain amount of protection of the filter elements 1 and of the filter material 4. For example, the filter material 4 can itself be formed in a multi-ply manner A configuration in which the filter material has a core of nonwoven material and is provided radially on the outside and radially on the inside with a metal net is in particular conceivable. The metal net results in intensive stabilisation of the filter material 4, but can be comparatively sharp-edged and thus present a source of injuries during handling of the filter elements 1. The sleeve 11 means that the filter elements 1 can easily be handled without direct contact with the filter material 4 being likely.

FIG. 4 shows by way of example a section of a woven textile material 16, which can be used to produce the sleeve 11. It has a warp/woof structure 17, which has warp fibres 18 and woof fibres 19. The warp fibres 18 run parallel to each other and the woof fibres 19 extend transversely to the warp fibres 18. The sleeve 11 is preferably produced with the textile material 16 in such a manner that in the finished sleeve 11 the warp fibres 18 are orientated parallel to the axial direction of the sleeve 11, while the woof fibres 19 extend in the circumferential direction of the sleeve 11, or vice versa. For example, the shrinkability in the circumferential direction can be much more pronounced than in the axial direction by corresponding selection of the fibre materials and/or fibre thicknesses.

1. A hydraulic filter element, comprising:
a cylindrical filter body having a filter material folded in a star-shaped manner,
having a cylindrical inner frame radially supported on an inside of the filter body,
having a cylindrical sleeve being permeable to a respective hydraulic medium and arranged radially against the outside of the filter body under prestress,
wherein the sleeve includes a knitted textile material.

2. The hydraulic filter element according to claim 1,
wherein the sleeve is shrunk onto the filter body, and
wherein the textile material which has greater shrinkage in the circumferential direction than in the axial direction.

3. The hydraulic filter element according to claim 1,
wherein textile material has a warp/woof structure having warp fibres which run parallel to each other and woof fibres which run transversely thereto, wherein the warp fibres and the woof fibres each include at least one different plastic from the other.

4. The hydraulic filter element according to claim 3, wherein the warp fibres run axially in the sleeve and the woof fibres extend in the circumferential direction.

5. The hydraulic filter element according to claim 1, wherein the textile material is elastically extended in the circumferential direction, and further wherein this circumferential extension produces the prestress.

6. The hydraulic filter element according to claim 5, wherein the textile material forming the sleeve has greater elastic extensibility in the circumferential direction than in the axial direction, and further wherein the textile material has an elastic extensibility of at least approximately 20% in the circumferential direction and an elastic extensibility of no more than approximately 10% in the axial direction.

7. The hydraulic filter element according to claim 5, wherein the textile material is configured to extend in the circumferential direction to such an extent that at least approximately 80% of its elastic extensibility in the circumferential direction is exhausted when the sleeve is in a mounted state.

8. The hydraulic filter element according to claim 1, wherein the prestress of the sleeve causes the filter material to bear against the inner frame.

9. A method for producing a hydraulic filter element, comprising:
applying a respective hydraulic medium to an outside of a filter material, wherein the filter material is folded in a star-shaped manner, pressing the filter material against an inner frame inserted into a filter body,
fixing in which the relative position between the filter material and the inner frame.

10. The method according to claim 9, further comprising:
shrinking the sleeve
wherein the fixing of the relative position between the filter material and the inner frame includes applying an end disc to each axial end of the filter body.

11. The hydraulic filter element according to claim 2, wherein the textile material has a structure having warp fibres which run parallel to each other and woof fibres which run transversely thereto, wherein the warp fibres and the woof fibres each include at least one different plastics.

12. The hydraulic filter element according to claim 6, wherein the textile material is configured to extend in the circumferential direction to such an extent that at least approximately 80% of its elastic extensibility in the circumferential direction is exhausted when the sleeve is in a mounted state.

13. The hydraulic filter element according to claim 2, wherein the prestress of the sleeve causes the filter material to bear against the inner frame.

14. The hydraulic filter element according to claim 3, wherein the prestress of the sleeve causes the filter material to bear against the inner frame.

15. The hydraulic filter element according to claim 4, wherein the prestress of the sleeve causes the filter material to bear against the inner frame.
